(19) United States
(12) Patent Application Publication
(10) Pub. No.: US 2011/0179479 A1
(43) Pub. Date: Jul. 21, 2011

(54) SYSTEM AND METHOD FOR GUARDING AGAINST DISPERSED BLOCKING ATTACKS

(75) Inventors: Jian-Gang Tsai, Taipei (TW); Yung-Hsing Chiu, Taipei (TW); Feng-Peng You, Taipei (TW)

(73) Assignee: CHUNGHWA TELECOM CO., LTD., Taipei (TW)

(21) Appl. No.: 12/815,133

(22) Filed: Jun. 14, 2010

(30) Foreign Application Priority Data
Jan. 15, 2010 (TW) 099101019

(51) Int. Cl. G06F 21/20

(52) U.S. Cl. 726/13

(57) ABSTRACT

A system and a method are provided for guarding against dispersed blocking attacks in a network. The system includes detection apparatus for detecting and guiding the dispersed blocking attacks, and a guarding apparatus for receiving and filtering the flow of packets guided by the detection apparatus. The guarding apparatus includes a filtering module for filtering irregular packets according to preset filtering rules; a routing device for receiving and transmitting the filtered flow of packets; and an adjusting module for analyzing the filtered flow of packets, thereby adjusting the preset filtering rules and providing warning messages. The method includes detecting, guiding and filtering, in a multi-layered manner, irregular packet flows at major nodes of the network; and enhancing filtering based on the analyzed and adjusted preset filtering rules, thereby preventing network services from being interrupted by dispersed blocking attacks.

### BACKGROUND OF THE INVENTION

1. Field of the Invention

This invention relates to systems and methods for guarding against dispersed blocking attacks, and, more particularly, to a system and a method that detect dispersed blocking attacks and guide and filter flow packets of the dispersed blocking attacks.

2. Description of Related Art

People rely on network connectivity and the Internet more than ever before. Accordingly, network safety issues exist in daily life. In particular, a server or a computer host is susceptible to network attacks. Therefore, people need a safe network environment.

Dispersed blocking attacks, known as Distributed Denial of Service (DDoS) attacks, are one of a variety of attacks that subject a computer to an overwhelming number of network packets. In dispersed blocking attacks, a large number of received packet transmissions requesting network services prevents the normal functionality of a host that provides services due to the consumption of bandwidth, host resources, or even paralyzing the hosts operating system. The current processing measures for coping with the great number of dispersed blocking attacks are not good enough. For processing measures guarding apparatus established on the client end itself, protection is limited by the available bandwidth, in that such measures cannot protect the system when the number of attacks exceeds the available bandwidth. For processing measures that take into account increased bandwidth demand or increased server workload, with attack scales being measured in MBs or GBs, ordinary enterprises that are equipped with a host having a bandwidth smaller than MBs cannot handle such attacks. For processing measures that involve Internet Service Providers (ISPs) blocking the destination IP addresses that are under attack, such measures cause the servers at the destination IP addresses to be unable to provide any services. For processing measures that attempt to thwart attacks by blocking the IP addresses of computers that are the source of attacks, such IP addresses are too numerous and scattered to be blocked effectively. For processing measures that limit the number of overseas attacks, these processing measures fail to block such attacks completely, as such blocking can be circumvented, and they typically block legitimate requests from overseas. For processing measures that change the IP addresses of servers that are attacked, DNS host settings in enterprises have to be changed in accordance with such changes, and it takes time for other external DNS hosts to be updated with the new IP addresses, during which time, legitimate users may be left without services. Moreover, dispersed blocking attacks may still acquire and attack the servers at the changed IP addresses.

In summary, user ends, enterprise hosts, service supply servers and even ISPs are still susceptible to dispersed blocking attacks. Generally, site administrators are not aware of these attacks until after they are attacked, and they cannot figure out other effective ways, besides passively blocking attack sources or blocking or changing the IP addresses that are under attack, to cope with these attacks. However, those mechanisms may affect legitimate packets using the same routes as the attack sources, and thus interrupt the provision of services. Accordingly, the current dispersed blocking attacks protection mechanisms are not robust enough.

Therefore, finding a way to provide network servers, when subjected to dispersed blocking attacks, with rapid relief or recovery of network services, so as to prevent legitimate clients from being denied services due to the attacks, is one of the most urgent issues in the art.

### SUMMARY OF THE INVENTION

In view of the above-mentioned problems of the prior art, the present invention provides a system and method for guarding against dispersed blocking attacks in a network that is applicable to detecting and guarding against dispersed blocking attacks, wherein, by detecting and analyzing irregular flows in the network, dispersed blocking attacks can be handled by filtering irregular packets, allowing legitimate clients to function normally.

The system includes detection apparatus for detecting dispersed blocking attacks that can guide away packets of the detected dispersed blocking attacks; and guarding apparatus for receiving and filtering the flow of packets guided away by the detection apparatus, the guarding apparatus having a filtering module for filtering irregular packets in the flow of packets according to preset filtering rules, a routing device for receiving the flow of packets filtered by the filtering module and transmitting the filtered flow of packets to a client end, and an adjusting module for capturing and analyzing the filtered flow of packets and adjusting the preset filtering rules in the filtering module and providing warning messages.

In an embodiment, the filtering module includes a packet fragment processing unit for filtering packet fragments in the flow of packets, and preventing the flow of packets from being divided; and an attack packet processing unit for filtering the filtered flow of packets filtered by the packet fragment processing unit with regard to attack packets.

In another embodiment, the guarding apparatus includes a plurality of filtering modules for distributing and filtering the flow of packets, the filtering modules having front ends connected to a front-end packet switching device and rear ends connected to a rear-end packet switching device, the front-end packet switching device and the rear-end packet switching device determining the filtering modules to which the flow of packets are guided according to a hash operation, whereby connection packets (e.g., TCP) and connectionless packets (e.g., UDP and ICMP) are filtered simultaneously.

In yet another embodiment, the system further includes an analysis module for mirroring the flow of packets that pass the filtering module, and analyzing the mirrored flow of packets, and the analysis module is connected to a packet information database for recording information about the analyzed flow of packets.

The method includes the following steps of: (1) detecting the flow of packets at major routing nodes in the network, and analyzing the flow of packets of irregular flows; (2) guiding the flow of packets to a protection region for packet filtering; (3) filtering the flow of packets according to preset filtering rules to filter out irregular packets in the flow of packets; and (4) analyzing the filtered flow of packets to adjust the preset filtering rules.

In an embodiment, the filtering rules have a connection number threshold value of a client end, and include an allowable connection number, a network address accessing frequency and/or an access request number.

In another embodiment, step (3) includes the following steps of: (3-1) filtering packet fragments in the flow of packets, and preventing the flow of packets from being divided; and (3-2) after the filtering of the fragmented packets, filtering the filtered flow of packets with regard to attack packets.

In yet another embodiment, the method further includes guiding the filtered flow of packets back to the client end to provide the client end with network services.

Compared with the prior art, the system and method for guarding against dispersed blocking attacks in a network according to the present invention perform detection at major network nodes to guide and filter the flow of packets of dispersed blocking attacks to a protection region, and use preset filtering rules to filter irregular packets to alleviate or reduce the impact on client end network services. Moreover, the filtered network packets are captured and analyzed, and the filtering rules are adjusted according to an analysis result, to thereby enhance filtering effects. The system for guarding against dispersed blocking attacks not only detects dispersed blocking attacks automatically but also provides a rapid-acting guarding mechanism, to thus reduce the extent of vulnerability of a client group to network attacks.

### BRIEF DESCRIPTION OF DRAWINGS

The invention can be more fully understood by reading the following detailed description of the preferred embodiments with reference made to the accompanying drawings, wherein:

FIG. 1 illustrates guiding packets in a system for guarding against dispersed blocking attacks according to the present invention;

FIG. 2 is a functional block diagram of a system for guarding against dispersed blocking attacks of a first embodiment according to the present invention;

FIG. 3 is a functional block diagram of a system for guarding against dispersed blocking attacks of a second embodiment according to the present invention;

FIG. 4 is a functional block diagram of a portion of a system for guarding against dispersed blocking attacks of third and fourth embodiments according to the present invention;

FIG. 5 is a functional block diagram of a system for guarding against dispersed blocking attacks of a fifth embodiment according to the present invention;

FIG. 6 is a flowchart of a method for guarding against dispersed blocking attacks according to the present invention; and

FIG. 7 is a flowchart of the third step of the method shown in FIG. 6.

### DETAILED DESCRIPTION OF PREFERRED EMBODIMENTS

The following illustrative embodiments are provided to illustrate the disclosure of the present invention, these and other advantages and effects being readily understood by those in the art after reading the disclosure of this specification. The present invention can also be performed or applied by other embodiments. The details of the specification may be changed in terms of features and applications, and numerous modifications and variations can be devised without departing from the spirit of the present invention.

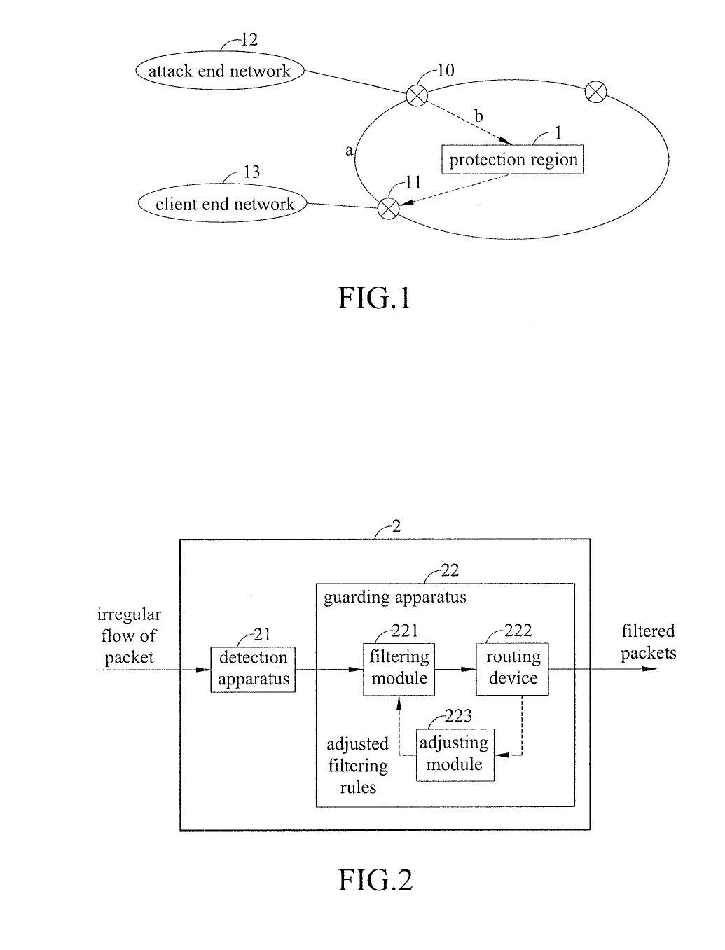

FIG. 1 illustrates guiding packets in a system for guarding against dispersed blocking attacks according to the present invention, and shows the routes of attack packets over the Internet. In general, the Internet is comprised of various backbone networks that include a plurality of major routing nodes, such as routing nodes 10 and 11 shown in FIG. 1, which are in turn connected to various networks. When an attack end network 12 attacks, a great number of attack packets are transmitted via the major routing node 10, along a route a to the routing node 11, and then to a client end network 13. Therefore, it is hard to provide a guarding function during the transmission process. The system for guarding against dispersed blocking attacks according to the present invention installs detection equipment at the routing node 10. When an attack begins, the whole flow of packets is guided to a protection region 1 to undergo a filtering process. Finally, the remaining filtered flow of packets are sent on to the client end network 13, to thereby prevent or reduce the damage caused by the dispersed blocking attack.

### The First Embodiment

FIG. 2 is a functional block diagram of a system 2 for guarding against dispersed blocking attacks of a first embodiment according to the present invention. The system 2 is applicable for detecting and guarding against dispersed blocking attacks in a network. The system 2 comprises detection apparatus 21 and guarding apparatus 22.

The detection apparatus 21 detects dispersed blocking attacks, and guides the flow of packets of the detected dispersed blocking attacks. The detection apparatus 21 is installed at each of the major routing nodes in a backbone network, such as the routing nodes 10 and 11 shown in FIG. 1. The detection apparatus 21 monitors the flow of packets at the routing nodes in the network. Since the dispersed blocking attacks (DDoS) are not virus attacks, dispersed blocking attacks paralyze a host server by hitting the host server with a great number of packets. Accordingly, the detection apparatus 21 detects whether any irregular flow in the network occurs, and, if an irregular flow is detected, guides the packets of the irregular flow to the guarding apparatus 22. The detection apparatus 21 has a plurality of parameter settings and may be finely adjusted according to practical requirements. For example, the detection apparatus 21 may be set to indicate that a 10 MB flow is an irregular flow or a 50 MB is a likely attack.

The guarding apparatus 22 receives and filters the flow of packets guided by the detection apparatus 21. The guarding apparatus 22 includes a filtering module 221, a routing device 222 and an adjusting module 223. The filtering module 221 filters irregular packets in the flow of packets according to preset filtering rules. The routing device 222 receives the flow packets filtered by the filtering module 221, and transmits the filtered flow of packets to a client end. The adjusting module 223 captures and analyzes the filtered flow of packets, to adjust the filtering rules in the filtering module 221 and provide warning messages.

In other words, the flow of packets filtered by the filtering module 221 are transmitted to the routing device 222 and captured and analyzed by the adjusting module 223, to obtain a number of irregular packets of the filtered flow of packets, and, if necessary, provide the warning messages. If it is found that the filtered flow of packets still permit a dispersed blocking attack to be in a highly dangerous state, not only are the warning messages provided but also the filtering rules are adjusted by the adjusting module 223, so as to enhance the packet-filtering process. At the same time, the flow of packets filtered by the filtering module 221 are transferred via the routing device 222 to the client end.

### The Second Embodiment

FIG. 3 is a functional block diagram of a system for guarding against dispersed blocking attacks of a second embodiment according to the present invention. The second embodiment differs from the first embodiment in that a guarding apparatus 32 of the system of the second embodiment further comprises a fragmented packet processing unit 3211 and an attack packet processing unit 3212.

The fragmented packet processing unit 3211 filters fragmented packets in the flow of packets, and prevents the flow of packets from being divided. In the second embodiment, the flow of packets guided by the detection apparatus 21 is received by a front end routing device 30 and transmitted to the filtering module 321 for further processing. Since the guided flow of packets may contain fragmented packets (IP fragmented packets), which are hard to filter out and may attack and paralyze the whole guarding apparatus 32 (because, in general, the guarding apparatus, when processing a great number of fragmented packets, cannot perform guarding determination unless the packets are organized), the guarding apparatus has to have relatively great system resources reserved for storing the unorganized fragments. In one kind of an attack, fragmented packets may be transmitted in such a great number that they cannot be organized successfully, thus quickly occupying the system resources of the guarding apparatus as it checks and attempts to organize the great number of fragmented packets, leading to malfunctioning equipment. Accordingly, in the second embodiment, packet filtering performed by the filtering module 321 is divided into two stages. In the first stage, the fragmented packet processing unit 3211 filters the fragmented packets by blocking fragmented packets that pass the fragmented packet processing unit 3211 and prevents the flow of packets that pass the fragmented packet processing unit 3211 from being divided again, so as to avoid affecting the subsequent packet filtering. In an embodiment, the fragmented packet processing unit 3211 may be a packet switch that has a fragmented packet blocking function. With the specific function, the packet switch is used for limiting the packets from being divided. Therefore, the divided packets, after the first packets that have the same serial number, may be discarded directly, to effectively reduce the whole load of the guarding apparatus 32. In the second stage, the attack packet processing unit 3212 then determines and filters the first irregular divided packets. Compared with the current large firewall that has the fragmented packet blocking function, the present invention, which uses the packet switch to realize the fragmented packet processing unit 3211, does not perform complicated steps, and may reduce maintenance difficulty and costs.

The attack packet processing unit 3212 filters out attack packets from the flow of packets that are filtered by the fragmented packet processing unit 3211. When the fragmented packet processing unit 3211 filters the fragmented packets, the attack packet processing unit 3212 filters out the attack packets from the flow of packets according to preset filtering rules, allowing the filtered flow of packets to only retain regular packets. Finally, the attack packet processing unit 3212 transmits the filtered flow of packets to the routing device 322 for transmission, and the adjusting module 323 captures and analyzes whether to adjust the preset filtering rules and provide warning messages.

The filtering rules use a connection number threshold value of the client end as a guarding parameter, wherein this guarding parameter includes an allowable connection number, a network address accessing frequency and/or an access request number. Accordingly, warning messages may be provided to a network manager timely according to a threshold value of the connection requirement (TCP/UDP/ICMP) appropriate for the client end. In particular, the filtering rules determine whether a request number of a connection and access requested for the flow of packets is within a regular range. If, based on the filtering rules, the packet service requests are determined to be regular, then the system allows the connection number of a source end, allows the source end to access the network at a specific frequency, or allows the network access request number. If the packet service requests are determined to be irregular, the filtering process is performed, and the same filtered packets are captured and analyzed again. If the dispersed blocking attacks are still not within a safe range, the adjusting module 323 may adjust the filtering rules automatically according to the filtered analysis data, thereby enhancing subsequent filtering effects.

### The Third Embodiment

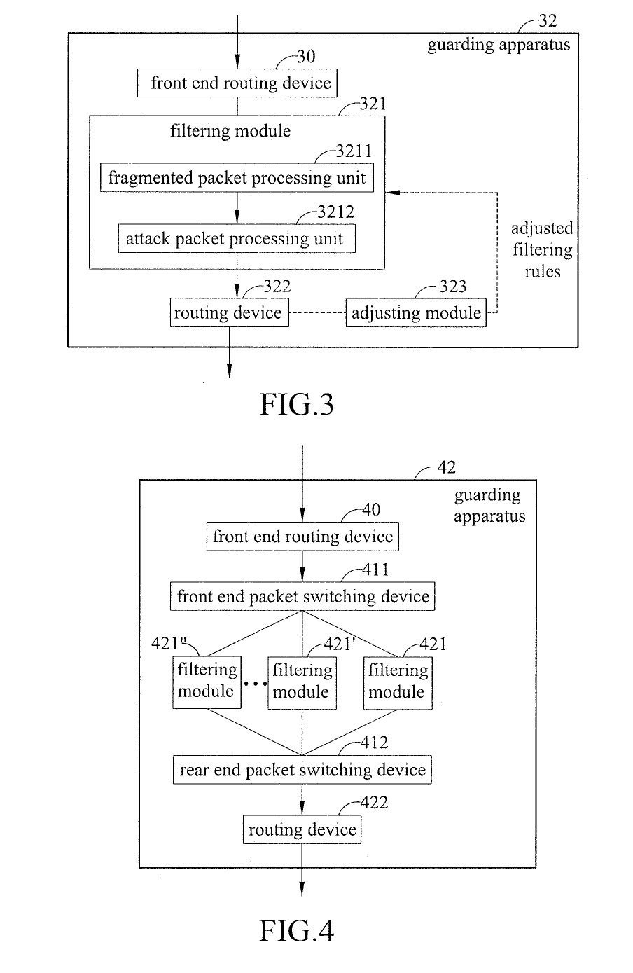

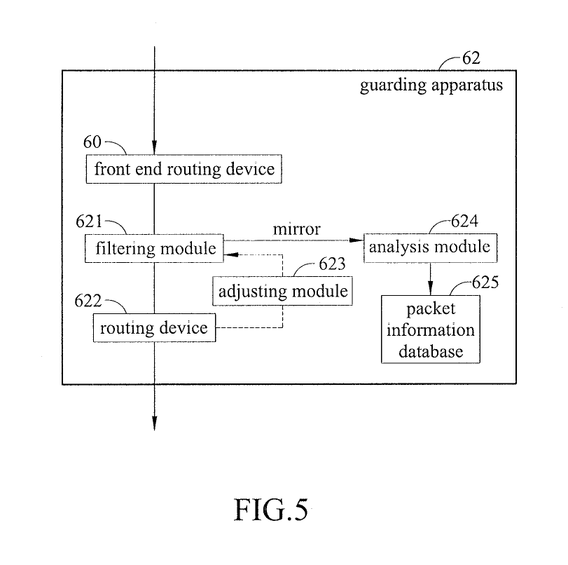

FIG. 4 is a functional block diagram of a portion of a system for guarding against dispersed blocking attacks of a third embodiment according to the present invention. In order to simplify the drawings and description, only the components of the system that relate to the third embodiment are shown in FIG. 4. The third embodiment differs from the second embodiment shown in FIG. 3 in that the guarding apparatus 42 of the third embodiment comprises a plurality of filtering modules 421, 421′ and 421″, for distributing and filtering the flow of packets. When an irregular flow of packets are guided to the guarding apparatus 42, the flow of packets are received by the front end routing device 40 and distributed and transferred by the front end packet switching device 411, allowing one of the filtering modules 421, 421′ and 421″ to filter the flow of packets. The filtered flow of packets are transmitted via the rear end packet switching device 412 and the routing device 422 to the client end.

Through the installation of the filtering modules, the whole system for guarding against dispersed blocking attacks may be more extendable. Accordingly, as the scale of attacks is increased, the guarding apparatus may be extended to endure the increased load of attacks. Preferably, each of the filtering modules may filter the packets according to their packet types, so as to disperse the load on the filtering modules and allow processing equipment to speed up the processing according to the packet characteristics. The number of the filtering modules may be adjusted according to practical demands.

### The Fourth Embodiment

In addition to relating to the third embodiment, FIG. 4 also provides a functional block diagram of a portion of a system for guarding against dispersed blocking attacks of a fourth embodiment according to the present invention. In order to simplify the drawings and description, only the components of the system that relate to the fourth embodiment are shown in FIG. 4. The fourth embodiment differs from the second embodiment shown in FIG. 3 in that the fourth embodiment may filter connectionless packets, e.g., user datagram protocol (UDP) or Internet control message protocol (ICMP) packets, and connection packets, e.g., transmission control protocol (TCP) packets, at the same time. A hash operation may be performed in the front end packet switching device 411 and the rear end packet switching device 412, to determine where the flow of packets need to flow.

Under the condition that the front end packet switching device 411 and the rear end packet switching device 412 of the fourth embodiment are not installed, the front end routing device 40, after receiving the flow of packets, may send the flow of packets to one of the filtering modules 421, 421′ and 421″ for filtering, and then transfer the flow of packets via the routing device 422. However, this type of packet transmission structure may encounter problems when transmitting connection packets, because the connection packets are highly complicated and the information therein cannot be interpreted without a dual-way communication. Therefore, if the routes along which the flow of packets go and come are different filtering modules (e.g., the flow packets are sent out via the filtering module 421 and sent back via another filtering module 421′), the contents contained in the packets cannot be determined.

Therefore, in an embodiment, a hash operation is performed in the front end packet switching device 411 and the rear end packet switching device 412 to determine the filtering module along which the flow packets should pass, thereby filtering connectionless and connection packets simultaneously. In practice, the front end packet switching device 411 performs the hash operation based on source IPs, to determine which port via which the flow of packets pass downward to one of the filtering modules. The rear end packet switching device 412 performs the hash operation with the same algorithm based on destination IPs, to determine which port via which the flow of packets flow upward back to the filtering module along which the original flow of packets flowed. In other words, the front end packet switching device 411 and the rear end packet switching device 412 perform the same hash operation to indicate transmission locations of the flow packets, to achieve process effects for the connection packets. The front end packet switching device 411 and the rear end packet switching device 412 may be realized by a packet switch. Accordingly, the front end packet switching device 411 may process fragmented packets and switch and distribute the flow of packets, such that the filtering modules 421, 421′ and 421″ connected to the front end packet switching device 411 may achieve load balancing. It is known from the system structures described in the third and fourth embodiments that load balancing may be achieved through a plurality of filtering modules, and connectionless and connection packets may be filtered simultaneously, such that packet filtering, load balancing and system extendibility may be achieved.

### The Fifth Embodiment

FIG. 5 is a functional block diagram of a system for guarding against dispersed blocking attacks of a fifth embodiment according to the present invention. In order to simplify the drawings and description, only the components of the system that relate to the fifth embodiment are shown in FIG. 5. The fifth embodiment differs from the aforesaid embodiments in that the guarding apparatus 62 in the fifth embodiment further comprises an analysis module 624. The analysis module 624 mirrors flow packets that pass a filtering module 621, and analyzes the flow packets. Before being sent by the front end routing device 60 to the filtering module 621 for filtering, a copy of the guided flow of packets that is formed in a mirror manner is transmitted to the analysis module 624 for analysis, to ascertain the current packet state in terms of irregular flow. The flow of packets guided originally are not affected, and are still filtered by the filtering module 621 and sent to the routing device 622. The adjusting module 623 captures and analyzes the flow of packets at the same time, in order to adjust the filtering rules and provide warning messages.

The analysis module 624 is connected to a packet information database 625. The packet information database 625 records information obtained after analyzing the flow of packets, to allow a network manager to check the state of irregular packets guided to the guarding apparatus 62.

In summary, the system for guarding against dispersed blocking attacks according to the present invention may detect dispersed blocking attacks at major nodes in a network, and guide the flow of packets of dispersed blocking attacks to a protection region to filter out irregular packets. Additionally, filtering rules may be adjusted by determining a threshold value, such as the number of permissible connections, to enhance filtering effects and for multi-layered protection to block single or mixed typed attacks.

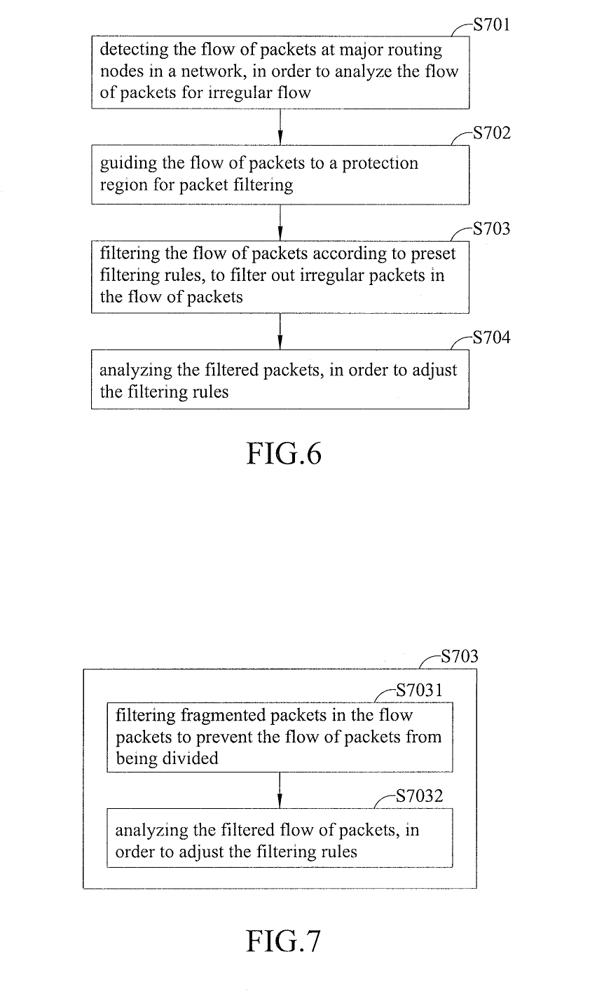

FIG. 6 is a flowchart of a method for guarding against dispersed blocking attacks according to the present invention. In step S701, the flow of packets at a major routing node in a network is detected, in order to analyze the flow of packets for irregular flow characteristics. When a network flow is detected to have irregular packets, monitoring and analysis are provided immediately to determine whether the network flow exceeds a preset threshold value, so as to determine whether dispersed blocking attacks exist and subsequent processing needs to be provided. Then proceed to step S702.

In step S702, the flow of packets is guided to the protection region for packet filtering. If the flow of packets is detected to be irregular, the flow of packets is guided to a protection region for a filtering process. In an embodiment, step S702 further comprises mirroring the guided flow packets, to provide analysis before the packets are filtered, so as to obtain the state of the flow of packets before being filtered. Then proceed to step S703.

In step S703, the flow of packets are filtered according to preset filtering rules, to filter out irregular packets in the flow of packets. In practice, the filtering rules filter and determine the nature of the flow of packets by taking a connection number threshold value of a client end as a guarding parameter, and taking the guarding parameter as a basis of the filtering rules, such as an allowable connection number, or a network address accessing frequency and an access request number of a network site. Thereby, irregular flows may be determined and irregular packets may be filtered.

In another embodiment, step S703 may further comprise distributing the flow of the flow of packets according to a hash operation, to filter connectionless and connection packets simultaneously. In particular, determining whether connectionless packets are attack packets may be conducted by a one-way process, while such a determination for the contents contained in connection packets may be done only by dual-way communication. Accordingly, with regard to connection packet characteristics, packet switching devices have to be installed at front and rear ends of equipment that processes attack packets and the packet switching devices have to perform the same hash algorithm. Performing a hash operation on source IPs and destination IPs to determine which port the flow packets are to be transmitted can achieve the filtering of various types of packets simultaneously. Then proceed to step S704.

In step S704, the filtered flow of packets are analyzed in order to adjust the filtering rules. The major object of this step is capturing and analyzing the filtered flow of packets to determine the current guarding effect. In practice, the filtered flow of packets are mirrored and then captured and analyzed, in order to adjust the filtering rules. If the filtering effect is not satisfied, the filtering rules are adjusted to enhance the filtering effect.

FIG. 7 is a flowchart of step S703. Step S703 further comprises step S7031 and step S7032. In step S7031, fragmented packets in the flow of packets are filtered, and the flow of packets are prevented from being divided. Then proceed to step S7032.

In step S7032, after the fragmented packets are filtered, attack packets contained in the remaining flow of packets are filtered again.

In practice, in step S7031 the fragmented packets are processed first, in order to avoid the fragmented packets from paralyzing the protection region, and limit the flow of packets from being divided. Then, attack packets contained in the filtered flow of packets in step S7031 are filtered, to provide a multi-layered guarding effect.

The method for guarding against dispersed blocking attacks according to the present invention may be combined with a backbone network of a certain ISP, to block attacks from a certain network completely, such as attacks from an overseas network. The overseas attacks may be blocked at routing nodes through which the attacks pass. Alternatively, packets form another ISP may be blocked, in order to guard a certain user. Therefore, better guarding effects may be provided through the combination of a plurality of mechanisms.

In conclusion, the present invention provides a system and a method for guarding against dispersed blocking attacks that are applicable to detecting and defending against dispersed blocking attacks. Compared with the prior art, the present invention automatically detects irregular flows in a network, guides packets of the irregular flows to a protection region, and filters out irregular packets contained therein according to filtering rules. The present invention may process various types of packets, such as fragmented packets and connection packets. The present invention may also analyze the filtering results and adjust the filtering rules, thereby enhancing the whole filtering effect, achieving multi-layered guarding, and reducing and alleviating network service interruption due to dispersed blocking attacks.

The foregoing descriptions of the detailed embodiments are illustrated to disclose the features and functions of the present invention and are not intended to be restrictive of the scope of the present invention. It should be understood by those in the art that many modifications and variations can be made according to the spirit and principles in the disclosure of the present invention and yet still fall within the scope of the appended claims.

What is claimed is:

1. A system for guarding against dispersed blocking attacks in a network, comprising:
detection apparatus for detecting the dispersed blocking attacks and guiding flow of packet of the detected dispersed blocking attacks; and
guarding apparatus for receiving and filtering the flow of packet guided by the detection apparatus, the guarding apparatus comprising:
a filtering module for filtering irregular packets in the flow of packet according to preset filtering rules;
a routing device for receiving the flow of packet filtered by the filtering module and transmitting the filtered flow of packets to a client end; and
an adjusting module for capturing and analyzing the filtered flow of packets, and adjusting the preset filtering rules in the filtering module and providing warning messages.

2. The system of claim 1, wherein the detection apparatus is installed at each of major routing nodes of the network, for monitoring the flow of packets at the routing nodes.

3. The system of claim 1, wherein the detection apparatus determines irregular flows of packets in the network and guides the irregular flows of packets to the guarding apparatus.

4. The system of claim 1, wherein the adjusting module analyzes the flow of packets that passes the routing device to obtain number of irregular packets in the flow of packets and adjust the preset filtering rules.

5. The system of claim 1, wherein the filtering rules comprise a connection number threshold value of a client end.

6. The system of claim 5, wherein the filtering rules include an allowable connections number, a network address accessing frequency and/or an access request number.

7. The system of claim 1, wherein the filtering module comprises:
a fragmented packet processing unit for filtering fragmented packets in the flow of packets, and preventing the flow of packets from being divided; and
an attack packet processing unit for filtering attack packets from the filtered flow of packets filtered by the fragmented packet processing unit.

8. The system of claim 1, further comprising an analysis module for mirroring the flow of packets that passes the filtering module, and analyzing the mirrored flow of packets.

9. The system of claim 8, wherein the analysis module is connected to a packet information database for recording information about the analyzed flow of packets.

10. The system of claim 1, wherein the guarding apparatus comprises a plurality of filtering modules for distributing and filtering the flow of packets.

11. The system of claim 10, wherein the filtering modules have front ends connected to a front end packet switching device and rear ends connected to a rear end packet switching device, the front end packet switching device and the rear end packet switching device determining the filtering modules to which the flow of packets are guided according to a hash operation, thereby filtering connection packets and connectionless packets simultaneously.

12. A method for guarding against dispersed blocking attacks in a network, comprising the steps of:
(1) detecting a flow of packets at major routing nodes in the network, and analyzing the flow of packets that is detected to be irregular;
(2) guiding the flow of packets to a protection region for packet filtering;
(3) filtering the flow of packets according to preset filtering rules to filter out irregular packets in the flow of packets; and
(4) analyzing the filtered flow of packets to adjust the preset filtering rules.

13. The method of claim 12, wherein step (2) comprises mirroring the flow of packets and analyzing the mirrored flow of packets.

14. The method of claim 12, wherein step (3) comprises the following steps of:
(3-1) filtering fragmented packets in the flow of packets, and preventing the flow of packets from being divided; and
(3-2) after the filtering of the fragmented packets, filtering attack packets from the filtered flow of packets.

15. The method of claim 12, wherein step (3) comprises performing flow distribution for the flow of packets according to a hash operation, thereby filtering connection packets and connectionless packets simultaneously.

16. The method of claim 12, wherein step (4) comprises capturing and analyzing the flow of packets, for providing warning messages and adjusting the preset filtering rules.

17. The method of claim 12, wherein the filtering rules are a connection number threshold value of a client end.

18. The method of claim 17, wherein the filtering rules comprise an allowable connection number, a network address accessing frequency and/or an access request number.

19. The method of claim 17, further comprising guiding the filtered flow of packets back to the client end, for providing the client end with network services.
